(19) United States
(12) Patent Application Publication
(10) Pub. No.: US 2002/0116610 A1
(43) Pub. Date: Aug. 22, 2002

(54) Customizable digital certificates

(76) Inventors: William S. Holmes, Santa Ana, CA (US); Brian Manahan, Aliso Viejo, CA (US)

Correspondence Address: Babak Redjaian, IRELL & MANELLA LLP, 840 Newport Center Drive, Suite 400, Newport Beach, CA, 92660, US

(21) Appl. No.: 09/791,212

(22) Filed: Feb. 22, 2001

(51) Int. Cl. H04L 9/00

(52) U.S. Cl. 713/156; 713/181

(57) ABSTRACT

A method and apparatus for providing a customizable digital certificate. In one embodiment, a method includes providing a digital certificate that includes a certificate public key, one or more public keys corresponding to one or more respective items of information, and at least one encrypted item of information each encrypted with a private key corresponding to a respective one of the one or more public keys. In another embodiment, the method includes providing digital data representing a certificate having a certificate public key and one or more encrypted items of information each encrypted with the certificate public key. The method further includes decrypting at least one encrypted item of information with a certificate private key corresponding to the certificate public key to provide at least one item of information, and including the at least one item of information in the certificate. The certificate or components thereof may be compiled by a certification authority and transmitted to a subscriber. The certificate may be generated locally by the subscriber. The subscriber may digitally sign an object and incorporate a certificate in the digital signature. Items of information include, for example, the subscriber's name, address, telephone, age, email address, authority within an organization, and the like. The present invention provides for customization of digital certificates, allowing the subscriber to specify the item(s) of information to be disclosed to recipients.

### BACKGROUND OF THE INVENTION

1. Field of the Invention

The present invention relates generally to security, and specifically, to the customization of digital certificates.

2. Description of the Related Art

With the rapid growth and emergence of the Internet connecting computers nationally and globally, people are now communication and transferring documents more and more via electronic means such as e-mail. Since electronic documents are easily alterable, usually without a trace, digital signatures were developed to digitally sign the electronic documents. Digital signatures are based on public key infrastructure (PKI) technology and use a combination of hashing and encryption to “encapsulate” the document in a form that proves the identity of the person sending the electronic document, and that the electronic document being viewed is the same document that was digitally signed.

PKI certificates are issued to subscribers and typically contain information about the subscriber of the certificate and may include the subscriber's name, email address, group, date of birth, title, buying/approval authority, credit limit, and any other information necessary for verification to a recipient. Each time the subscriber signs a document, object, or email, the whole certificate is incorporated in the signature. As the certificate is verified, every part of it is readable by every recipient of a digitally signed document, object, or email.

This is a drawback because a subscriber may not want to divulge all of the subscriber's information with a signature. To overcome this drawback, subscribers typically have a number of different certificates, each containing appropriate information selected by the subscriber. This requires the creation, maintenance, correct selection, and use of multiple certificates.

### BRIEF SUMMARY OF THE INVENTION

The present invention comprises a method and apparatus for providing a customizable digital signature. In one embodiment, a method includes receiving, from a certification authority, digital data representing a certificate public key, one or more public keys corresponding to one or more respective items of information, and one or more encrypted items of information encrypted with one or more private keys corresponding to the one or more respective public keys. The method further includes providing a digital certificate that includes the certificate public key, the one or more public keys, and at least one of the one or more encrypted items of information.

In another embodiment, the method includes providing digital data representing a certificate having a certificate public key and one or more encrypted items of information each encrypted with the certificate public key. The method further includes decrypting at least one encrypted item of information with a certificate private key corresponding to the certificate public key to provide at least one item of information, and including the at least one item of information in the certificate.

Other embodiments are described and claimed herein.

### BRIEF DESCRIPTION OF THE DRAWINGS

FIG. 1 illustrates a block diagram of an exemplary system for creation, dissemination, and verification of digital certificates suitable for use with the present invention.

FIG. 2 shows an exemplary list of one or more items of information.

FIG. 3 shows an exemplary diagram of a Basic Certificate, according to one embodiment of the present invention.

FIG. 4 shows an exemplary embodiment of an Information Certificate, according to one embodiment of the present invention.

FIG. 5 shows an exemplary mechanism for creating a Working Certificate, according to one embodiment of the present invention.

FIG. 6 illustrates a logical block/ flow diagram for digitally signing an object.

FIG. 7 illustrates a logical block/flow diagram of a module on a recipient computer system, according to one embodiment of the present invention.

FIG. 8 shows an exemplary mechanism for obtaining the item(s) of verification information on a recipient computer system, according to one embodiment of the present invention.

FIG. 9 illustrates a block diagram of a computer system, according to one embodiment of the present invention.

FIG. 10 shows an exemplary diagram of a Basic Certificate, according to another embodiment of the present invention.

FIG. 11 shows an exemplary mechanism for creating a Working Certificate, according to another embodiment of the present invention.

FIG. 12 shows an exemplary diagram of the query-response process, according to one embodiment of the present invention.

FIG. 13 shows an exemplary diagram of a verification process, according to one embodiment of the present invention.

### DETAILED DESCRIPTION

The present invention comprises a method and apparatus for providing a customizable digital signature. In one embodiment, the method includes receiving, from a certification authority, digital data representing a certificate public key, one or more public keys corresponding to one or more respective items of information, and one or more encrypted items of information encrypted with one or more private keys corresponding to the one or more respective public keys. The method further includes providing a digital certificate that includes the certificate public key, the one or more public keys, and at least one of the one or more encrypted items of information. A subscriber may then digitally sign an object, and incorporate the certificate public key, one or more public keys, and at least one of the one or more encrypted items of information in the digital signature.

In another embodiment, a method includes providing digital data representing a certificate having a certificate public key and one or more encrypted items of information each encrypted with the certificate public key. The method further includes decrypting at least one encrypted item of information with a certificate private key corresponding to the certificate public key to provide at least one item of information, and including the at least one item of information in the certificate.

Items of information include, for example, the subscriber's name, address, email address, age, title, organization, department within organization, authority level, citizenship status, credit card number and expiration, picture, biometrics information, and any other piece(s) of information a subscriber wishes to provide.

As discussed herein, a “computer system” is a product including circuitry capable of processing data. The computer system may include, but is not limited to, general purpose computer systems (e.g., server, laptop, desktop, palmtop, personal electronic devices, etc.), personal computers (PCs), hard copy equipment (e.g., printer, plotter, fax machine, etc.), banking equipment (e.g., an automated teller machine), and the like. “Media” or “media stream” is generally defined as a stream of digital bits that represent data, audio, video, facsimile, multimedia, and combinations thereof. A “communication link” is generally defined as any medium over which information may be transferred such as, for example, electrical wire, optical fiber, cable, plain old telephone system (POTS) lines, wireless (e.g., satellite, radio frequency “RF”, infrared, etc.) and the like. Information is defined in general as media and/or signaling commands.

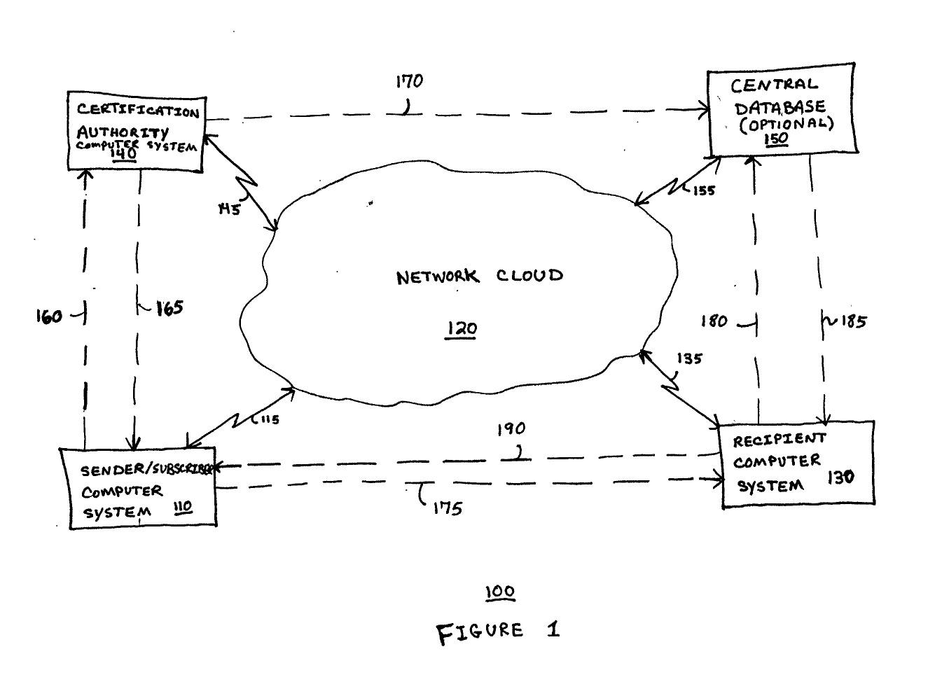

FIG. 1 illustrates a block diagram of an exemplary system 100 for creation, dissemination, and verification of digital certificates suitable for use with the present invention. For sake of clarity and to provide a non-restrictive example, the system 100 will be described with respect to public key infrastructure (PKI) certificates. However, it is to be understood that the present invention may be used with all types of digital certificates and digital certificate protocols.

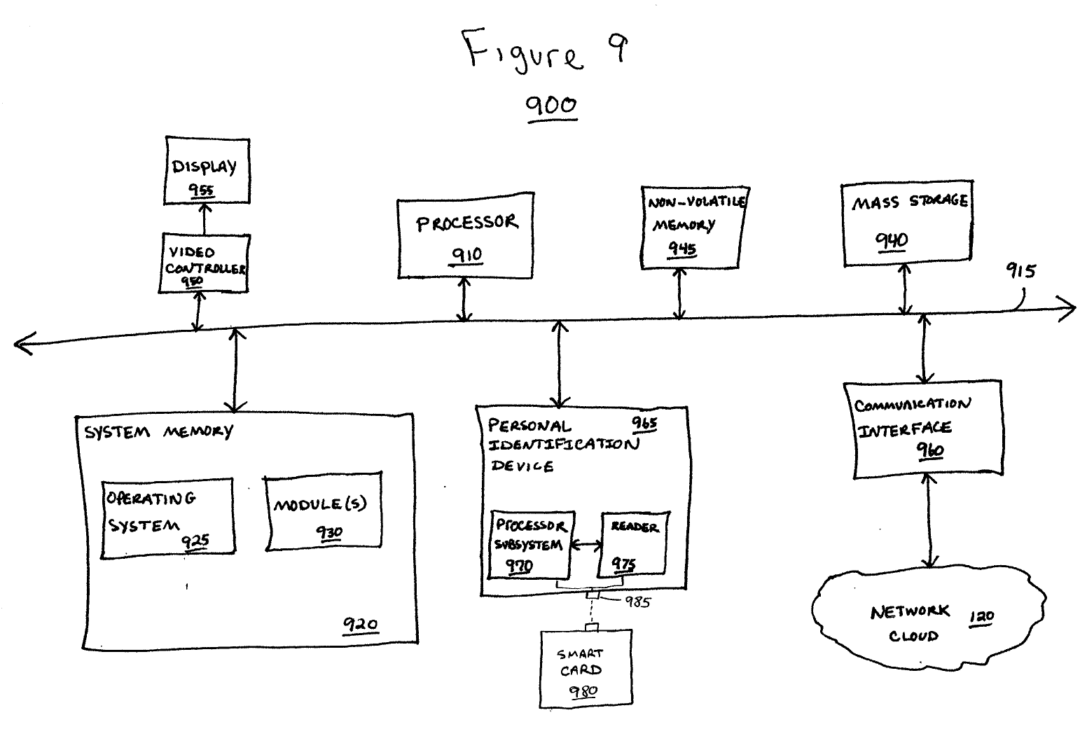

Referring to FIG. 1, the system 100 includes computer systems 110 and 130 of a sender/subscriber and recipient, respectively. The computer systems 110 and 130 are coupled to a network cloud 120 via communication links 115 and 135, respectively. Each of the computer systems 110 and 130 includes a processor, memory, communication circuitry, etc. and software running thereon for digitally signing and verifying digitally signed objects (e.g., documents, e-mails, etc.) using certificates (e.g., PKI certificates) according to embodiments of the present invention. An object may include, but not limited to, a data file, document, email, image, multimedia, form, request, and challenge for authentication that requires (e.g., immediate) authentication of the user. A subscriber creates and/or loads an object on computer system 110, and digitally signs the object, before transmission over the network cloud 120 to one or more recipients. The digital signature incorporates therein a customizable certificate, embodiments of which are presented herein. A recipient, on computer system 130, retrieves the customizable certificate, and verifies the digital signature accompanying the object. The recipient can also view or authenticate the subscriber's information that is provided in the customizable certificate. The recipient can request for necessary items of information from the subscriber such as by using a query-response process. FIG. 9 shows an exemplary embodiment of a computer system that may be used by any of the computer systems in FIG. 1.

In one embodiment, the network cloud 120 includes a local area network (LAN), wide area network (WAN), Internet, other global computer network, Intranet, one or more direct link connections, and/ or combinations thereof. For sake of clarity and to provide a non-restrictive example, the network cloud 120 will also be referred to herein as the Internet.

The system 100 also includes a computer system 140 of a certification authority that is coupled to the network cloud 120 via communication link 145. The certification authority computer system 140 creates and issues customizable digital certificates of the present invention or components thereof. In one embodiment, the block 140 represents more than one computer system coupled together via a local network (not shown), operated by the certification authority. The certification authority is a trusted third party that can confirm the identity of a subscriber that digitally signs an object. The computer system 140 may include software for running an Internet portal that hosts web pages, allowing subscribers to obtain customizable digital certificates or components thereof.

The system 100 further includes a central database 150 that includes and is operated by a computer system (not labeled or shown). The database 150 (as part of a computer system) is coupled to the network cloud 120 via communication link 155. In one embodiment, the database stores a list of authorized/valid digital certificates, and optionally a list of invalid certificates. The database 150 may be located at and/or controlled by the certification authority. The database 150 may be integrated as part of the computer system 140.

Continuing to refer to FIG. 1, a subscriber at computer system 110 requests from the certification authority (computer system 140) a customizable digital certificate of the present invention or components thereof, as shown by dashed arrow 160. In one embodiment, the subscriber requests/provides one or more of the following items of information (or information elements) to be included in the digital certificate: the subscriber's name, address, email address, telephone number, age, organization, title in organization, department within organization, authority level, citizenship status, picture, biometrics, and the like.

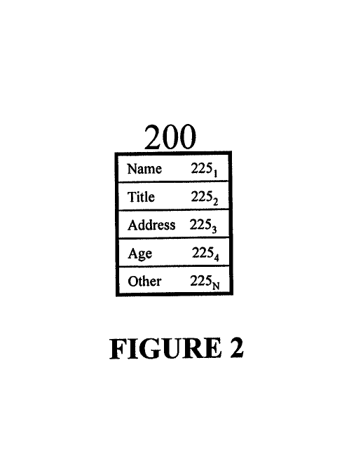

FIG. 2 shows an exemplary list 200 of one or more items of information 225₁-225_{N}, where “N” is a positive whole number. In this exemplary list 200, the subscriber's Name (225₁), Title (225₂), Address (225₃), Age (225₃), and other items of information (225_{N}) are provided. This list may be created and/or generated by the certification authority (e.g., on computer system 140) or by the subscriber (e.g., on computer system 110). The certification authority may verify each item of information that the subscriber intends to include in the customizable digital certificate.

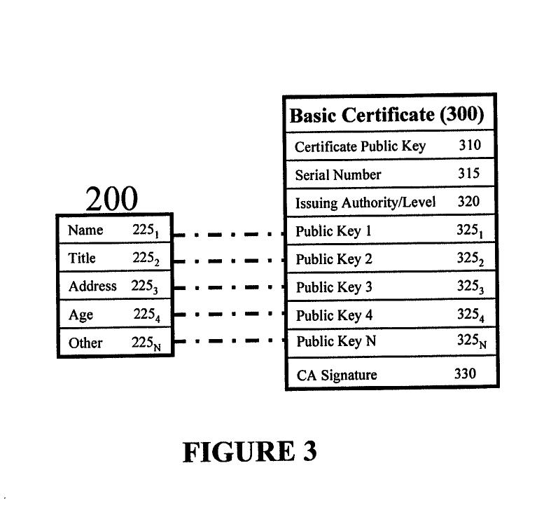

Once the item(s) of information has/have been defined, the certification authority creates a “Basic Certificate.” FIG. 3 shows an exemplary diagram of a Basic Certificate 300, according to one embodiment of the present invention. Referring to FIG. 3, the Basic Certificate 300 includes a certificate public key field 310, serial number field 315, issuing authority/level field 320, public key fields 325₁-325_{N}, and a CA signature field 330. The certificate public key field 310 includes a traditional public key used to decrypt a digital signature. The certificate private key corresponding to the public key is securely and/or separately transferred to the subscriber. The serial number field 315 includes a unique serial number assigned to the Basic Certificate by the certification authority. The issuing authority/level field 320 identifies the name and other related information of the certification authority.

Public key fields 325₁-325_{N} include respective public keys 1 through N corresponding to the N items of information provided, as shown by dashed lines. Each public key in fields 325₁-325_{N} is a different public key. That is, the Basic Certificate includes a public encryption key for each item of information 225₁-225_{N} to be included in the certificate. For example, if two items of information are provided, then two different public keys would be included in the certificate, if three items of information are provided, then three different public keys would be included in the certificate, and so on. Each public key may identify the information that is to be decrypted using the key. The CA signature field 330 includes the certification authority digital signature. The Basic Certificate may include other fields that have not been shown. Such fields include, for example, a validity field specifying the period of validity of the digital certificate, a version field, etc.

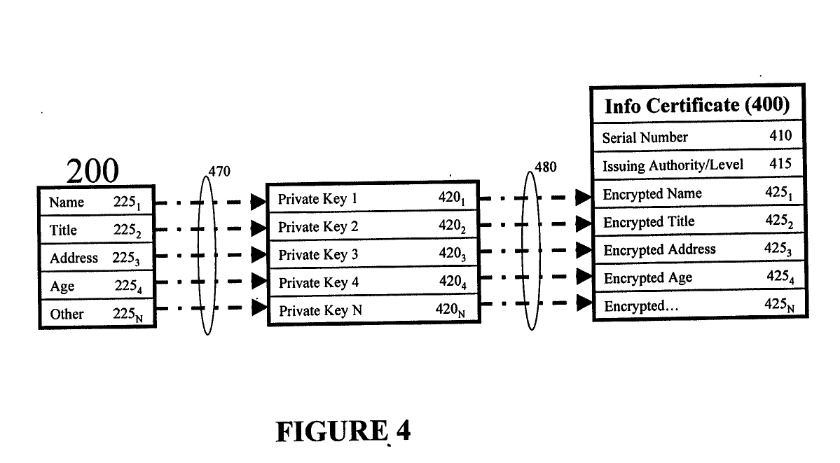

The certification authority also creates an Information (Info) Certificate. FIG. 4 shows an exemplary embodiment of an Information Certificate, according to one embodiment of the present invention. Referring to FIG. 4, the certification authority uses private keys 420₁-420_{N} corresponding to the public keys in fields 325₁-325_{N} (FIG. 3) to individually encrypt each verified item of information (items 225₁-225_{N}, as shown by dashed lines 470, to produce (dashed lines 480) respective encrypted items of information in fields 425₁-425_{N}. The encrypted items of information 425₁-425_{N} are assembled in the Information Certificate 400. The Information Certificate 400 may also include a serial number field 410 and an issuing authority/level field 415. After creation of the encrypted items of information 425₁-425_{N} and/or the Information Certificate 400, the certification authority may destroy the private keys 420₁-420_{N}. The Information Certificate may include other fields. The creation of the Basic Certificate 300 and the Information Certificate 400 may be implemented in software using, for example, one or more modules.

In another embodiment, the subscriber may obtain components of the Basic and Information Certificates 300 and 400 from the certification authority, and may then create the Basic and Information Certificates 300 and 400 locally. For example, the subscriber may obtain the certificate public key 310, public keys 325₁-325_{N}, private keys 420₁-420_{N}, encrypted items of information 425₁-425_{N}, and/or other information from the certification authority. The subscriber can then create a customizable digital certificate locally.

Referring back to FIG. 1, the certification authority transmits, via computer system 140, the Basic Certificate 300 (FIG. 3) and Information Certificate 400 (FIG. 4) or components contained therein, to the subscriber (computer system 110), as shown by dashed arrow 165. The Basic and Information Certificates 300 and 400 may be sent separately (e.g., as separate files) or together (e.g., a single data stream). The certification authority optionally transmits the subscriber's certificate to the optional central database 150, as shown by dashed arrow 170. Each time a subscriber wants to digitally signs an object, the subscriber may create a Working Certificate that accompanies the signed object.

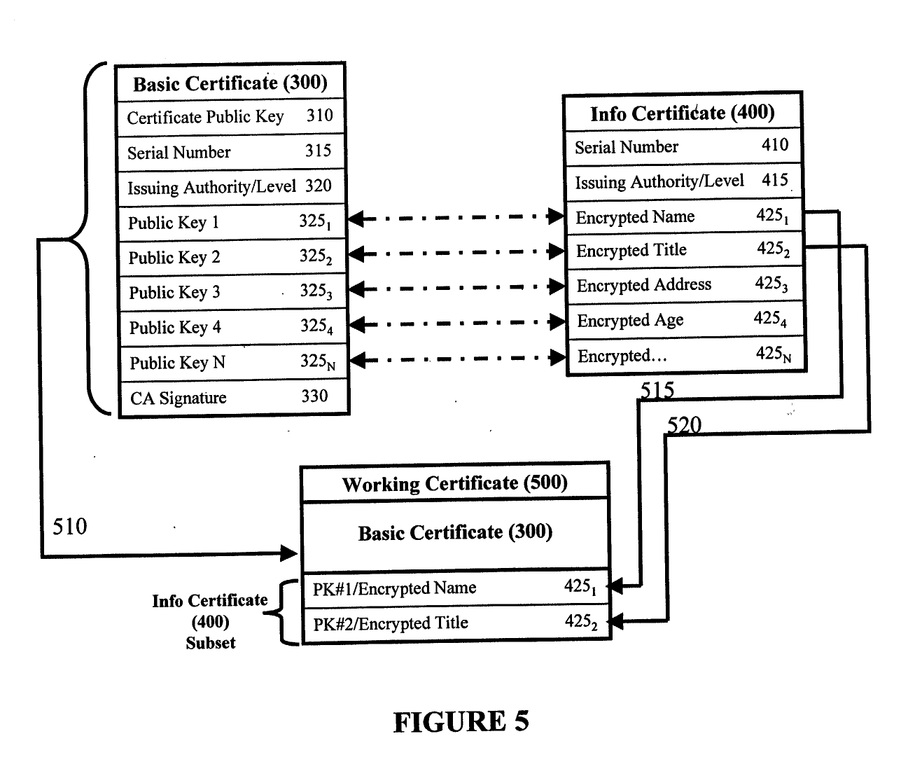

FIG. 5 shows an exemplary mechanism for creating a Working Certificate 500, according to one embodiment of the present invention. Referring to FIG. 5, the Working Certificate 500 incorporates or includes at least a portion of the Basic Certificate 300 (arrow 510) and one or more encrypted items of information from the Information Certificate 400. At signing time, the user specifies the item(s) of information to be included in the Working Certificate 500 to accompany the signed object. As a result, the Working Certificate 500 is assembled so that it contains only the item(s) of information required or desired for the transaction. For example, if a subscriber only wants to provide the subscriber's name and title when signing an object, the subscriber selects only those items to be included in the Working Certificate 500. Consequently, encrypted items 425₁and 425₂ are incorporated into the Working Certificate, as shown by arrows 515 and 520.

By way of another example, if the subscriber wants to digitally sign a request to access an adult content website that requires age verification, the subscriber can simply include only the subscriber's age without providing the subscriber's name or any other personal information. This allows the subscriber to maintain complete anonymity while satisfying the adult content website's age verification needs. Thus, the present invention provides for customization of digital certificates, allowing the subscriber to specify the item(s) of information to be disclosed to recipients.

In one embodiment, the CCITT X.509 standard certificate may be extended to incorporate the customizable digital certificate of the present invention, embodiments of which are presented herein. It is to be noted that the any digital certificate protocol, whether a standard or not, may be extended to incorporate the customizable digital certificates of the present invention.

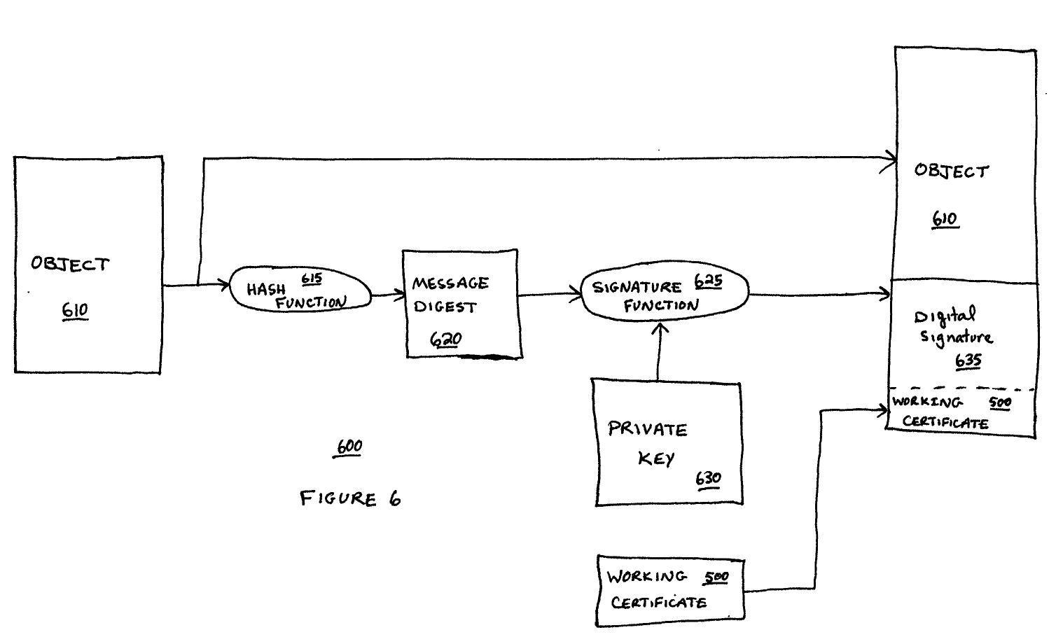

FIG. 6 illustrates a logical block/flow diagram 600 for digitally signing an object. Referring to FIG. 6, an object 610 is applied to a hash function 615. In one embodiment, the hash function 615 performs a mathematical algorithm on the object 610, and outputs a message digest 620, which is a string of bits. The hash function 615 takes a variable input (e.g., object 610), and generates an output that is generally smaller than the input. The message digest 620 is then fed to a signature function 625.

The signature function 625 uses the sender's private signing key 630 to encrypt the message digest 620. The private key 630 is obtained securely from the certification authority, and corresponds to the certificate public key 310 (FIG. 3). The private key 630 may be stored on a “smart” card 980 (FIG. 9) where the message digest 620 is uploaded to the “smart” card, and encrypted with the private key to perform the signature function 625. The output of the signature function 625 is a digital signature 635, which is then packed, appended, and/or concatenated with the object 610 and the Working Certificate 500. The Working Certificate 500 includes components of the Basic Certificate 300 and one or more encrypted item(s) of information (from the Info Certificate 400) selected by the subscriber to be included in the digital certificate.

The object 610, digital signature 635 and Working Certificate 500 are then transmitted to the recipient(s), e.g., via the Internet, a direct connection, a floppy disk that is handed or delivered to the recipient(s), etc. The object 610 may optionally be encrypted prior to transmission. Referring back to FIG. 1, this is shown by dashed arrow 175.

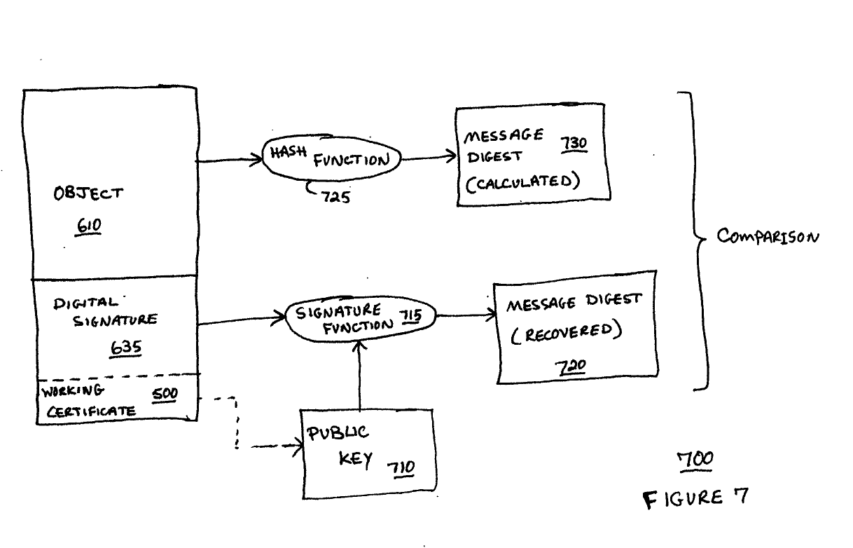

FIG. 7 illustrates a logical block/flow diagram of a module 700 on a recipient computer system 130, according to one embodiment of the present invention. The recipient computer system 130 receives (e.g., over the Internet) or loads (e.g., from a disk) the object 610, digital certificate 635, and Working Certificate 500, which may be stored on mass storage 940 (FIG. 9).

Referring to FIG. 7, the certificate public key is retrieved from the Working Certificate 500, as public key 710, or from a previous copy of the Basic Certificate. The digital signature 635 is applied to a signature function 715. Using the retrieved public key 710, the digital signature 635 is decrypted, providing the retrieved message digest 720. The object 610 is also applied to a hash function 725 which operates on the object 610, using the same hash algorithm as used on the subscriber's computer system, to yield a (calculated) message digest 730. The type and version of the hash function used is typically included in the Working Certificate 500.

The (calculated) message digest 730 is then compared with the (received) message digest 720 to determine the integrity of the digital signature. If the two files are unequal, then the digital signature is not valid, and authentication cannot be confirmed. A message may be sent to a display stating that the digital signature is not valid. Consequently, viewing of the object may be disallowed.

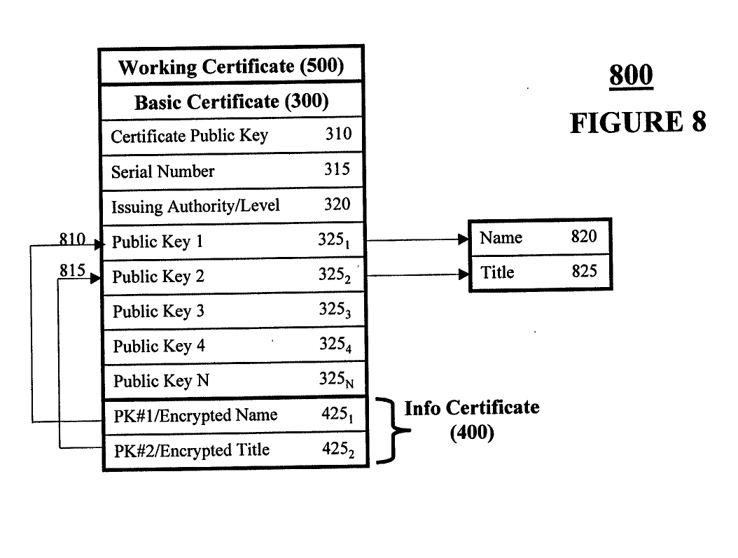

FIG. 8 shows an exemplary mechanism 800 for obtaining and/or retrieving the item(s) of verification information on a recipient computer system, according to one embodiment of the present invention. In the example provided, the encrypted items of information 425₁ and 425₂ included in the Working Certificate 500 include pointers 810 and 815, respectively, to the corresponding public keys 325₁ and 325₂. Using the public keys 325₁ and 325₂, the recipient can decrypt the Encrypted Name 425₁ and Encrypted Title 425₂, respectively, to verify the subscriber's name 820 and title 825. However, the recipient cannot obtain any other information regarding the subscriber since the corresponding encrypted item(s) of information were not provided by the subscriber.

Referring back to FIG. 1, once the recipient verifies the digital signature, the recipient sends an optional request to the optional central database 150 to check the validity of the subscriber's digital certificate, as shown by dashed arrow 180. The computer system operating the central database 150 sends an optional message back to the recipient specifying the status of the subscriber's digital certificate (e.g., valid), as shown by dashed arrow 185. Once the subscriber's digital certificate is verified, the recipient may optionally send a confirmation message back to the subscriber, as shown by dashed arrow 190.

FIG. 9 illustrates a block diagram of a computer system 900, according to one embodiment of the present invention. For sake of clarity, the computer system 900 is described with respect to the subscriber and/or recipient computer system 110 or 130 (FIG. 1), or the certification authority computer system 120.

Referring to FIG. 9, the computer system 900 includes a processor 910 that is coupled to a bus structure 915. The processor 910 may include a microprocessor such as a Pentium™ microprocessor, microcontroller, or any other of one or more devices that process data. Alternatively, the computer system 900 may include more than one processor. The bus structure 915 includes one or more buses and/or bus bridges that couple together the devices in the computer system 900.

The processor 910 is coupled to a system memory 920 such as a random access memory (RAM), non-volatile memory 945 such as an electrically erasable programmable read only memory (EEPROM) and/or flash memory, and mass storage device 940. The non-volatile memory 945 includes system firmware such as system BIOS for controlling, among other things, hardware devices in the computer system 900.

The computer system 900 includes an operating system 925, and one or more modules 930 that may be loaded into system memory 920 from mass storage 940 at system startup and/or upon being launched. The operating system 925 includes a set of one or more programs that control the computer system's operation and allocation of resources. In one embodiment, the operating system 925 includes, but not limited or restricted to, disc operating system (DOS), Windows™, UNIX™, and Linux™. In one embodiment, one or more modules 930 are application programs, drivers, subroutines, and combinations thereof. One or more module(s) and/or application program(s) or portions thereof may be loaded and/or stored in the processor subsystem 970 and/or the “smart” card 980 (e.g., in non-volatile memory). One or more of the modules and/or application programs may be obtained via the Internet or other network.

On a certification authority computer system (140), the one or more application programs and/or modules are used to create Basic and Information Certificates, and transmit the certificates to the subscriber's computer system to allow creation of a customizable Working Certificate of the present invention. On a subscriber computer system (110), one or more application programs and/or modules may be used to digitally sign objects using a customizable digital certificate of the present invention. On a recipient computer system, one or more application programs and/or modules may be used to verify a digital signature, and verify the subscriber's selected information provided in the customizable digital certificate.

The mass storage device 940 includes (but is not limited to) a hard disk, floppy disk, CD-ROM, DVD-ROM, tape, high density floppy, high capacity removable media, low capacity removable media, solid state memory device, etc., and combinations thereof. In one embodiment, the mass storage 940 is used to store documents, where digitally signed or not, a viewer program/module, etc. The mass storage may also store the operating system and/or modules that are loaded into system memory 920 at system startup.

The computer system 900 also includes a video controller 950 for driving a display device 955, and a communication interface 960 such as a Ti connection for communicating over the network cloud 120 (FIG. 1).

Also coupled to the bus structure 915 is an optional personal identification device 965 that includes a processor subsystem 970 and a card reader/writer 975, which may optionally include a keypad. The processor subsystem 970 includes a microprocessor or microcontroller, memory, and software running thereon for communicating with the card reader/writer 975 and other module(s) and/or devices in the computer system 900. In one embodiment, a user's private signing key and other information such as the user's personal information and PIN may be stored on a “smart” card 980, which includes a processor, memory, communication interface (e.g., serial interface), etc. Optionally, the personal identification device 965 or the card reader/writer 975 may include or may be coupled to one or more biometrics devices to scan in the user's thumb print, perform a retinal scan, and read other biometrics information. In such a case, the “smart” card 980 may include a digital representation of the user's thumb print, retinal scan, and the like.

When digitally signing documents or other objects, the user connects the “smart” card 980 to the card reader/writer 975 or some other location on the personal identification device 965 (e.g., via a serial port 985). Optionally, the keypad on the card reader/writer 975 may include a display that prompts the user to “Enter in a PIN” and/or “Provide biometrics authentication” (e.g., a thumb print). The PIN provided by the user is then uploaded to the “smart” card 980 via the serial port 985. The “smart” card 980 then compares the PIN entered on the keypad and the PIN stored on the “smart” card. The “smart” card may also compare biometrics information (e.g., a user's thumb print) stored thereon with biometrics information scanned or otherwise obtained from the user. If there is a mismatch, the user may be prompted with a message such as “Incorrect PIN. Please Enter correct PIN”. If they match, the “smart” card then requests the message digest 620 (FIG. 6) from the computer system for encrypting the message digest with the user's private signing key. The message digest 620 may be stored in system memory 920, mass storage 940, and/or other location. The message digest may be retrieved through the processor subsystem 970 or directly from the processor 910. In either case, the “smart” card reads the message digest, and encrypts the same with the user's private signing key to provide a digital signature. The memory on the “smart” card 980 includes encryption algorithm and software for generating the digital signature based on the private key.

In another embodiment, the comparison of the PIN stored on the “smart” card 980 and the PIN entered by the user on the keypad, and the encryption of the message digest with the user's private signing key may be performed by the processor subsystem 970. In such a case, the “smart” card downloads the PIN and the private key stored thereon to the processor subsystem 970.

It is to be noted that embodiments of the present invention are not limited to the use of “hard” certificates (e.g., a smart card), but can equally be used with “soft” certificates, which do not require smart cards or personal identification devices.

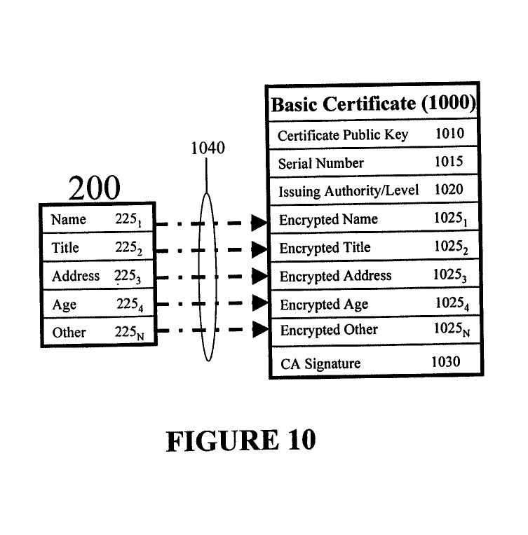

FIG. 10 shows an exemplary diagram of a Basic Certificate 1000, according to another embodiment of the present invention. In this embodiment, the Basic Certificate 1000 includes a certificate public key field 1010, serial number field 1015, issuing authority/level field 1020, encrypted item fields 1025₁-1025_{N}, and CA signature field 1030. Fields 1010, 1015, 1020, and 1030 are similar to the respective fields 310, 315, 320, and 330 of the Basic Certificate 300 of FIG. 3. The certificate private key corresponding to the public key in field 1010 is securely and/or separately transferred to the subscriber. The encrypted item fields 1025₁-1025_{N} correspond to the N items of information 225₁-225_{N} (in list 200) provided by the subscriber. Each item of information in fields 225₁-225_{N} is individually encrypted with the Certificate Public Key 1010. The dashed lines 1040 represent an encrypt operation with the Certificate Public Key 310. The CA Certificate field 330 includes the certification authority signature of all data in the Basic Certificate 1000 including the encrypted items 325₁-325_{N}, certificate public key 310, serial number 315, issuing authority/level 320, and other optional plain-text personal information (not shown in FIG. 10). The Basic Certificate 1000 may include other fields that have not been shown. Such fields could include, but are not limited to, a validity field specifying the period of validity of the digital certificate, a version field, etc.

Optionally, the items of information in fields 225₁-225_{N} may be padded (e.g., at the end) with random data before being encrypted. By adding a random pad to the end of each item of information, the ability to determine the true value of the data in the corresponding fields 1025₁-1025_{N} becomes much harder.

Referring now to FIGS. 1 and 10, the certification authority transmits, via computer system 140, the Basic Certificate 1000 to the subscriber (computer system 110), as shown by dashed arrow 165. The certification authority may optionally transmit the subscriber's certificate to the optional database 150, as shown by arrow 170. Alternatively or additionally, the certification authority may provide the subscriber with the certificate public key (and corresponding private key), and one or more of the serial number, issuing authority/level, and CA signature, to allow the subscriber to locally generate the Basic Certificate 1000 or variations thereof.

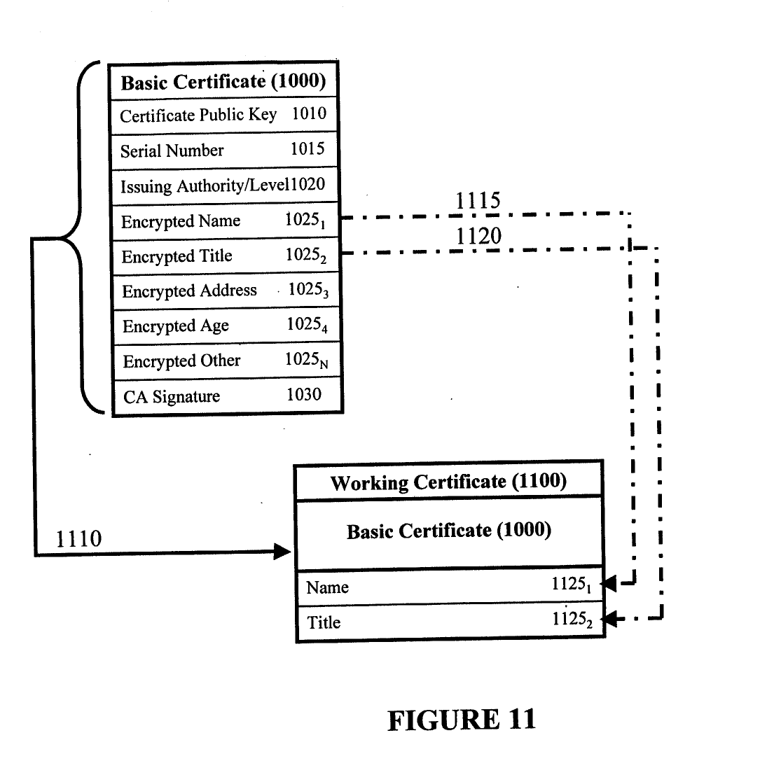

In one embodiment, the subscriber may create a Working Certificate when the subscriber wished to use the customizable certificate to provide information without being queried for it. FIG. 11 shows an exemplary mechanism for creating a Working Certificate 1100, according to another embodiment of the present invention. Referring to FIG. 11, the Working Certificate 1100 incorporates or includes at least a portion of the Basic Certificate 1000 (arrow 1110) and one or more decrypted items of information the subscriber wishes to provide. For sake of illustration, the decrypted items of information include the Name 1125₁ and Title 1125₂. The decrypted Name 1125₁ and Title 1125₂ are obtained by decrypting, using the subscriber's certificate private key, the Encrypted Name 1025₁ and Encrypted Title 1025₂ from the Basic Certificate 1000. The dashed arrows 1115 and 1120 represent the decryption operation with the subscriber's certificate private key of the Encrypted Name 1025₁ and Encrypted Title 1025₂, respectively. The subscribers certificate private key corresponds to or is associated with the certificate public key 1010, and is transmitted from the certification authority to the subscriber securely and/or separately. Thus, each item of information that the subscriber wishes to supply in the Working Certificate 1100 is individually decrypted and placed in plan-text into the Working Certificate 1100.

At time of use, the subscriber specifies the item(s) of information to be included in the Working Certificate 1100. The Working Certificate 1100 is assembled so that it contains the plain-text of only the item(s) of information selected for the desired operation. The Working Certificate 1100 could be used for/with (but such use is not limited or restricted to) digital signatures, SSL authentication, key exchange, authentication, and access control.

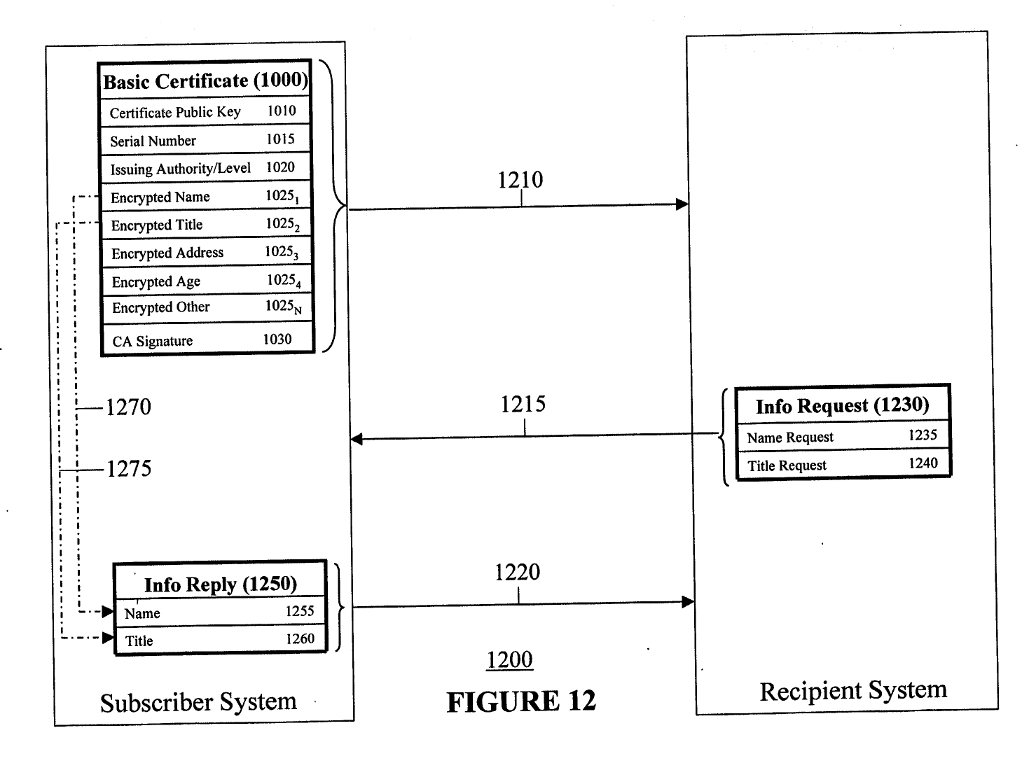

In another embodiment, the subscriber may provide information to one or more recipients through a query-response process. FIG. 12 shows an exemplary diagram of a query-response process 1200, according to one embodiment of the present invention. As shown therein, the subscriber initially sends the Basic Certificate 1000 to the recipient while performing any normal operation that uses a certificate (e.g., SSL client authentication), as represented by arrow 1210. The recipient receives the certificate and notices the information that it requires is encrypted. The recipient then creates an Information Request packet 1230 that includes a request for one or more item(s) of information. In this exemplary embodiment, the requests include a Name Request 1235 and a Title Request 1240. The Information Packet 1230 is transmitted to the subscriber, as represented by arrow 1215. The subscriber then has the option to either provide the information or reject the request if the subscriber does not wish to divulge such information. If the subscriber wishes to provide the information, the subscriber creates an Information Reply packet 1250. The Information Reply packed 1250 is populated much in the same way that the Working Certificate 1100 (FIG. 11) is populated. That is, the Information Reply packet 1250 is populated by decrypting the requested item(s) of information from the Basic Certificate 1000 using the subscriber's certificate private key corresponding to the certificate public key 1010. The decrypted item(s) of information are then placed in the Information Reply packet 1250. In the current example, the Encrypted Name 1025₁ and Encrypted Title 1025₂ are decrypted and placed in the Name 1255 and Title 1260 fields in the Information Reply packet 1250. The dashed arrows 1270 and 1275 represent a decryption operation for the Encrypted Name 1025₁ and Encrypted Title 1025₂, respectively, using the certificate private key. Once the Information Reply packet 1250 is populated it is transmitted to the recipient system as represented by arrow 1220.

Whether the information that is sent to the recipient is provided via a Working Certificate 1100 (FIG. 11) or through a query-response process (FIG. 12), the recipient can verify that the information provided is correct and has the backing of the certification authority.

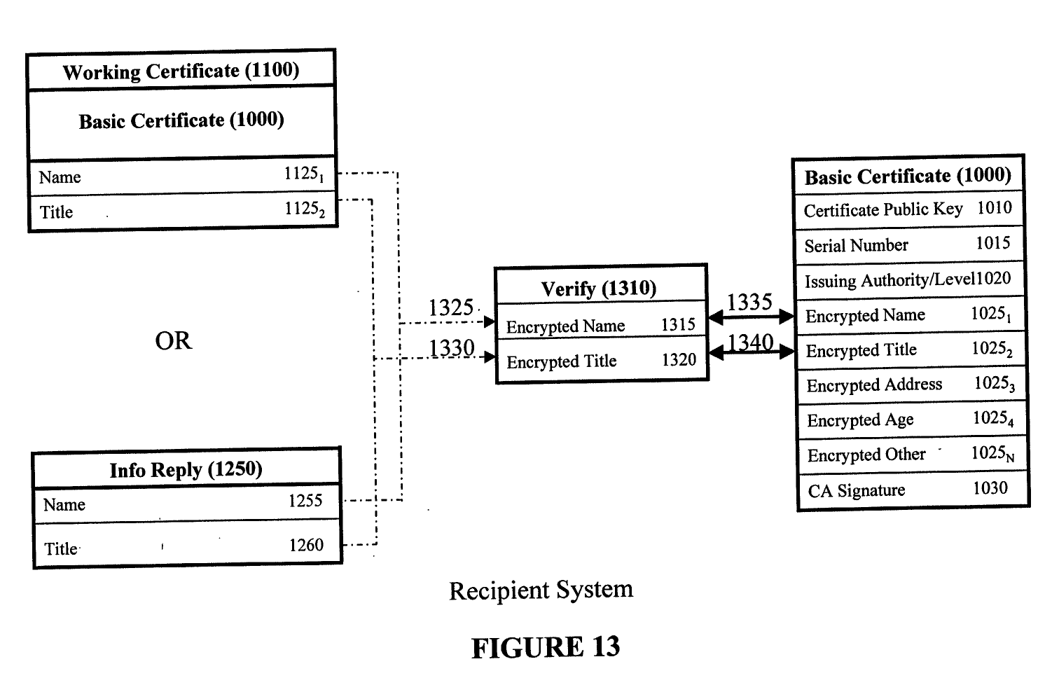

FIG. 13 shows an exemplary diagram of the verification process, according to one embodiment of the present invention. In order to verify the information, the recipient performs an encryption operation on the plain-text information to be validated from either a Working Certificate 1100 or an Information Reply packet 1250. The encryption operation is done with the certificate public key 1010 from the Basic Certificate 1000, as represented by dashed arrows 1325 and 1330. The results of the encryption operation are shown in the Verify Information 1310 as Encrypted Name 1315 and Encrypted Title 1320. Each value in the Verify Information 1310 is checked to make sure that it is exactly equal to the corresponding value in the Basic Certificate 1000, as depicted by comparison arrows 1335 and 1340. Thus, for example, if Encrypted Name 1315 is equal to Encrypted Name 1025₁, then the information is know to be correct. If the corresponding values are not equal then the information is known to be false and should not be trusted. Since the certification authority signed the Basic Certificate 1000 and thus encrypted information, the same level of trust given to the certification authority can be assumed by the information validated.

Embodiments of the present invention may be implemented as a method, apparatus, system, etc. When implemented in software, the elements of the present invention are essentially the code segments to perform the necessary tasks. The program or code segments can be stored in a processor readable medium or transmitted by a computer data signal embodied in a carrier wave over a transmission medium or communication link. The “processor readable medium” may include any medium that can store or transfer information. Examples of the processor readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method, comprising:
receiving, from a certification authority, digital data representing a certificate public key, one or more public keys corresponding to one or more respective items of information, and one or more encrypted items of information encrypted with one or more private keys corresponding to the one or more respective public keys; and
providing a digital certificate that includes the certificate public key, the one or more public keys, and at least one of the one or more encrypted items of information.

2. The method of claim 1 wherein the one or more items of information include one or more of the following: name, address, email address, age, title, organization, department within organization, authority level, citizenship status, credit card number and expiration, picture, and biometrics information.

3. The method of claim 1 further comprising:
hashing an object to provide a message digest; and
digitally signing the message digest with a private key corresponding to the certificate public key to provide a digital signature.

4. The method of claim 1 further comprising:
hashing an object to provide a message digest;
digitally signing the message digest with a private key corresponding to the certificate public key to provide a digital signature; and
incorporating the digital certificate into the digital signature.

5. The method of claim 3 further comprising:
transmitting the object, digital signature, and digital certificate to one or more recipients over a network.

6. The method of claim 5 wherein the object comprises one or more of the following: a data file, document, email, image, multimedia, challenge for authentication, request, and form.

7. A computer readable medium having stored therein instructions for causing a central processing unit to execute the method of claim 1.

8. The method of claim 5 further comprising:
receiving, by a recipient, the object, digital signature, and digital certificate;
decrypting each of the at least one encrypted items of information with a respective public key to provide at least one item of information.

9. The method of claim 8 further comprising:
decrypting the digital signature using the certificate public key to provide a recovered message digest;
hashing the object to provide a calculated message digest;
determining whether the recovered message digest and the calculated message digest are identical; and
providing verification of the digital signature if the recovered message digest and the calculated message digest are identical.

10. A method, comprising:
providing digital data representing a first certificate including a certificate public key and one or more public keys corresponding to one or more items of information;
providing digital data representing a second certificate including one or more encrypted items of information encrypted with one or more private keys corresponding to the one or more public keys; and
transmitting the first and second certificates.

11. The method of claim 10 wherein prior to providing, the method further comprising:
receiving, from a subscriber, the one or more items of information; and
creating one or more different public keys and corresponding private keys corresponding to the one or more items of information.

12. The method of claim 11 further comprising:
encrypting each of the one or more items of information with a respective private key to provide the one or more encrypted items of information.

13. The method of claim 10 wherein the one or more items of information include one or more of the following: name, address, email address, age, title, organization, department within organization, authority level, citizenship status, credit card number and expiration, picture, and biometrics information.

14. A computer readable medium having stored therein instructions for causing a central processing unit to execute the method of claim 10.

15. The method of claim 13 further comprising:
receiving the first and second certificates on a computer system; and
providing a digital certificate that includes the certificate public key, the one or more public keys, and at least one of the one or more encrypted items of information.

16. The method of claim 15 wherein the one or more items of information include one or more of the following: name, address, email address, age, title, organization, department within organization, authority level, citizenship status, credit card number and expiration, picture, and biometrics information.

17. The method of claim 16 further comprising:
hashing an object to provide a message digest; and
digitally signing the message digest with a private key corresponding to the certificate public key to provide a digital signature.

18. The method of claim 17 further comprising:
transmitting the object, digital signature, and digital certificate to one or more recipients over a network.

19. The method of claim 18 wherein the object comprises one or more of the following: a document, email, image, multimedia, request, and form.

20. The method of claim 17 further comprising:
receiving, by a recipient, the object, digital signature, and digital certificate;
decrypting each of the at least one of encrypted items of information with a respective public key to provide at least one item of information.

21. The method of claim 20 further comprising:
decrypting the digital signature using the certificate public key to provide a recovered message digest;
hashing the object to provide a calculated message digest;
determining whether the recovered message digest and the calculated message digest are identical; and
providing verification of the digital signature if the recovered message digest and the calculated message digest are identical.

22. A system, comprising:
a network;
a first computer system coupled to the network, said first computer system to (i) receive a request for a digital certificate, (ii) create digital data representing a certificate public key, one or more public keys corresponding to one or more items of information, and one or more encrypted items of information encrypted with one or more private keys corresponding to the one or more public keys, and (iii) transmit the digital data representing the certificate public key, one or more public keys, and one or more encrypted items of information; and
a second computer system coupled to the network, said second computer system to (i) transmit the request for the digital certificate, (ii) receive the digital data representing the certificate public key, one or more public keys, and one or more encrypted items of information, (iii) and provide a digital certificate that includes the certificate public key, the one or more public keys, and at least one of the one or more encrypted items of information.

23. The system of claim 22 wherein the second computer system to further hash an object to provide a message digest, digitally signing the message digest with a private key corresponding to the certificate public key to provide a digital signature, and transmit the object, digital signature, and digital certificate.

24. A method, comprising:
receiving, from a certification authority, digital data representing a certificate public key and one or more public keys corresponding to one or more items of information;
receiving, from the certification authority, digital data representing one or more encrypted items of information encrypted with one or more private keys corresponding to the one or more public keys; and
providing a digital certificate that includes the certificate public key, the one or more public keys, and at least one of the one or more encrypted items of information.

25. A digital certificate method, comprising:
receiving one or more items of information;
providing digital data representing a first certificate including a certificate public key, one or more public keys corresponding to one or more items of information, and one or more encrypted items of information encrypted with one or more private keys corresponding to the one or more public keys; and
transmitting the certificate public key, one or more public keys, and one or more encrypted items of information.

26. The digital certificate method of claim 25 wherein the one or more items of information include one or more of the following: name, address, email address, age, title, organization, department within organization, authority level, citizenship status, credit card number and expiration, picture, and biometrics information.

27. A method, comprising:
receiving, from a certification authority, digital data representing a certificate public key, and one or more encrypted items of information each separately encrypted with the certificate public key; and
providing a digital certificate that includes the certificate public key and at least one of the one or more encrypted items of information.

28. The method of claim 27 wherein the one or more encrypted items of information include one or more of the following: an encrypted name, encrypted address, encrypted email address, encrypted age, encrypted title, encrypted organization, encrypted department within organization, encrypted authority level, encrypted citizenship status, encrypted credit card number and expiration, encrypted picture, and encrypted biometrics information.

29. The method of claim 27 further comprising:
hashing an object to provide a message digest; and
digitally signing the message digest with a private key corresponding to the certificate public key to provide a digital signature.

30. The method of claim 29 further comprising:
further including in the digital certificate at least one item of information corresponding to the at least one of the one or more encrypted items of information; and
transmitting the object, digital signature, and digital certificate to one or more recipients over a network.

31. The method of claim 30 further comprising:
decrypting at least one of the one or more encrypted items of information using a certificate private key corresponding to the certificate public key, to provide the at least one item of information.

32. The method of claim 30 wherein the object comprises one or more of the following: a data file, document, email, image, multimedia, challenge for authentication, request, and form.

33. A computer readable medium having stored therein instructions for causing a central processing unit to execute the method of claim 27.

34. The method of claim 30 further comprising:
receiving, by a recipient, the object, digital signature, and digital certificate;
encrypting each of the at least one item of information with the certificate public key to provide at least one recovered encrypted item of information; and
comparing each of the at least one recovered encrypted item of information with a corresponding one of the one or more encrypted items of information to authenticate each item of information.

35. The method of claim 34 further comprising:
decrypting the digital signature using the certificate public key to provide a recovered message digest;
hashing the object to provide a calculated message digest;
determining whether the recovered message digest and the calculated message digest are identical; and
providing verification of the digital signature if the recovered message digest and the calculated message digest are identical.

36. A method, comprising:
providing digital data representing a certificate that includes a certificate public key and one or more encrypted items of information each encrypted with the certificate public key;
transmitting the certificate.

37. The method of claim 36 wherein the one or more encrypted items of information include one or more of the following: an encrypted name, encrypted address, encrypted email address, encrypted age, encrypted title, encrypted organization, encrypted department within organization, encrypted authority level, encrypted citizenship status, encrypted credit card number and expiration, encrypted picture, and encrypted biometrics information.

38. The method of claim 36 further comprising:
receiving the certificate, by a recipient;
transmitting, from the recipient to the subscriber, a request for at least one requested item of information;
receiving the request, by a subscriber;
transmitting a reply including the at least one requested item of information each corresponding to a respective one of the one or more encrypted items of information;
receiving the reply, by the recipient; and
encrypting each of the at least one requested item of information with the certificate public key to provide at least one recovered encrypted item of information; and
comparing each of the at least one recovered encrypted item of information with a corresponding one of the one or more encrypted items of information to authenticate the requested item of information.

39. The method of claim 36 wherein providing digital data comprises providing digital data representing the certificate that includes a certificate public key, one or more encrypted items of information each encrypted with the certificate public key, and one or more items of information corresponding to the one or more encrypted items of information each decrypted using a certificate private key corresponding to the certificate public key.

40. The method of claim 39 further comprising:
receiving the certificate by a recipient;
encrypting each of the one or more items of information with the certificate public key to provide one or more recovered encrypted items of information; and
comparing each of the one or more recovered encrypted items of information with a respective one of the one or more encrypted items of information to authenticate each item of information.

41. A computer readable medium having stored therein instructions for causing a central processing unit to execute the method of claim 36.

42. A computer system, comprising:
a memory including one or more instructions;
a processor, coupled to the memory, the processor, in response to the one or more instructions, to,
provide a digital certificate that includes a certificate public key and one or more encrypted items of information each encrypted with the certificate public key,
decrypt at least one of the one or more encrypted items of information with a certificate private key corresponding to the certificate public key to provide at least one item of information, and
include in the digital certificate the at least one item of information.
